(19) United States
(12) Patent Application Publication
(10) Pub. No.: US 2007/0017265 A1
(43) Pub. Date: Jan. 25, 2007

(54) LOCK DEVICE

(75) Inventor: Daniel Andersson, Eskilstuna (SE)

Correspondence Address: HOLLAND & HART, LLP, P.O BOX 8749, DENVER, CO, 80201, US

(73) Assignee: ASSA AB, Eskilstuna (SE)

(21) Appl. No.: 11/458,016

(22) Filed: Jul. 17, 2006

(30) Foreign Application Priority Data
Jul. 22, 2005 (SE) 0501724-9

(51) Int. Cl. E05B 17/04; E05B 9/10

(52) U.S. Cl. 70/379 R

(57) ABSTRACT

A lock device comprises a cylinder house (10) and a substantially cylindrical cylinder core (20), which is rotatably accommodated in the cylinder house and fixed against axial displacement relative thereto. A tailpiece (40) is rotatably accommodated in the cylinder house and fixed against axial displacement relative thereto. An interconnection means, such as a pin (26), is radially moveable between a disconnecting position, wherein it engages only the cylinder core, and an interconnecting position, wherein it engages both the cylinder core and the tailpiece. By providing an interconnection means that is movable radially to engage a tailpiece, a simple and yet flexible design is achieved.

### FIELD OF INVENTION

The present invention relates generally to lock devices and more particularly to a lock cylinder having a free-turning function between the cylinder core and the tailpiece.

### BACKGROUND

Lock cylinders are arranged to transfer a rotational movement from a cylinder core to a tailpiece provided to actuate a lock mechanism in for example a lock case the cylinder core can be turned by means of e.g. a key or a knob. In many lock cylinders, a blocking mechanism is provided to allow only an authorized user to operate the lock cylinder. This blocking mechanism prevents turning of the cylinder core for example in the case an incorrect key is inserted in the lock cylinder.

As an alternative to a blocking mechanism preventing turning of the cylinder core, an arrangement can be provided which decouples or disconnects the cylinder core from the tailpiece. In this case, when an incorrect key is inserted in the lock cylinder, the cylinder core can be freely rotated without causing rotation of the tailpiece. This prevents the lock device from being readily wrenched or pried apart.

The international patent publication WO 2005/001224 A1 discloses a lock device with a free-turning function. The disclosed solution is however limited to lock devices of the so-called DIN standard and discloses no tailpiece at the end of a lock cylinder.

### SUMMARY OF THE INVENTION

An object of the present invention is to provide a lock device of the kind initially mentioned which has a simple design and readily adapts itself for different configurations of the tailpiece.

The invention is based on the realisation that a coupling means between the cylinder core and the tailpiece can be arranged for movement in a radial direction between an interconnecting and a disconnecting position.

According to the invention there is provided a lock device as defined in appended claim 1.

Further preferred embodiments are defined by the dependent claims.

Thus there is provided a lock device having a simple design and which still is easy to adapt to different configurations.

### BRIEF DESCRIPTION OF DRAWINGS

The invention is now described, by way of example, with reference to the accompanying drawings, in which:

FIGS. 1a and 1b are exploded perspective views of a first embodiment of a lock device according to the invention;

FIGS. 1c and 1d are sectional views of the lock device shown in FIGS. 1a and 1b in a disconnected and inter-connected position, respectively, of an interconnecting means;

FIGS. 2a-b are views corresponding to FIGS. 1a-b but showing a second embodiment of a lock device according to the invention; and

FIGS. 3a-b are views corresponding to FIGS. 1a-b but showing a third embodiment of a lock device according to the invention.

### DETAILED DESCRIPTION OF THE INVENTION

In the following a detailed description of preferred embodiments of the present invention will be given.

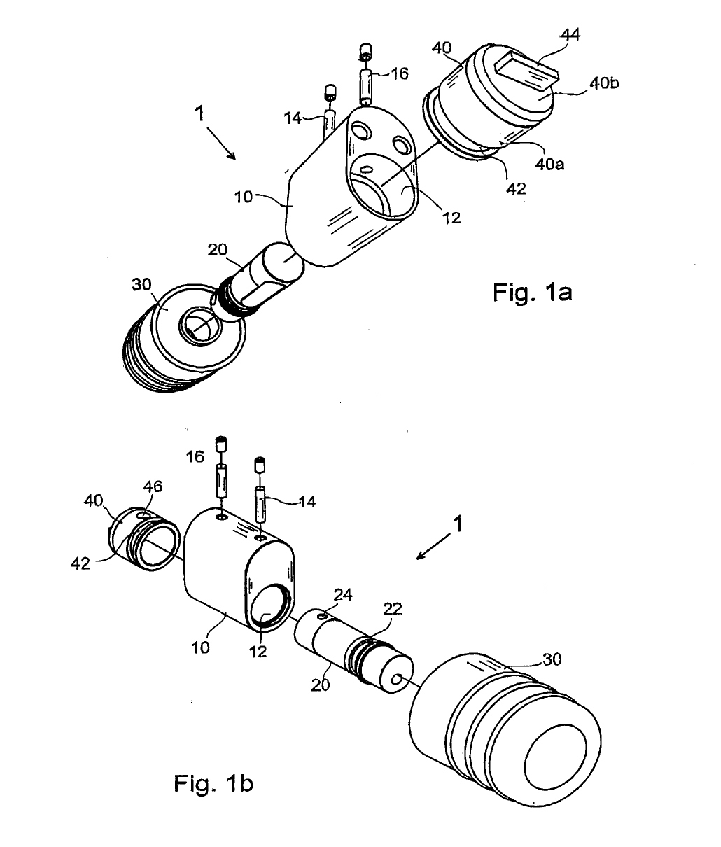

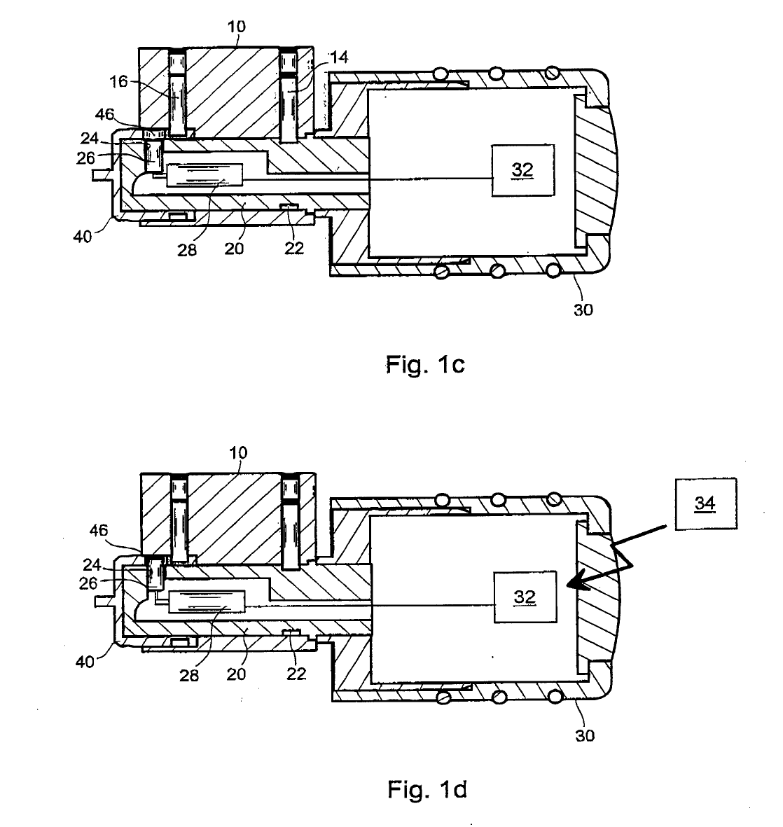

A lock cylinder, generally designated 1, is shown in exploded perspective view in FIGS. 1a and 1b. The lock cylinder comprises a cylinder house 10 having a circular cavity or bore 12 extending axially through the full length of the lock cylinder. A cylindrical cylinder core 20 is arranged rotatably in the cavity and is fixated axially by means of a lock pin 14 in the cylinder house engaging a circumferential groove 22 on the envelope surface of the cylinder core. A knob 30 is attached to the outer end portion of the cylinder core 20. This knob comprises electronic authorization means, such as a microprocessor, control electronics, antenna etc., generally designated 32, see FIGS. 1c and 1d.

A cup shaped tailpiece 40 having a cylindrical portion 40a and an essentially planar bottom 40b is rotatably provided in the cavity 12 at the end opposite to the end at which the knob 30 is attached. Thus, the tailpiece is provided at one end of the lock device 1. The tailpiece is fixated axially by means of a lock pin 16 in the cylinder house engaging a circumferential groove 42 on the envelope surface of the tailpiece. An integrated coupling 44 is arranged on the end surface of the tailpiece 40, being arranged to cooperate with a lock mechanism provided in a lock case, for example.

The cylinder core 20 comprises a radial hole 24, see FIG. 1b. Also the tailpiece 40 comprises a hole 46 through the cylindrical portion thereof. As can been seen from the sectional view of FIG. 1c, the inner diameter of the cylindrical portion (40a) of the cup shaped tailpiece 40 is slightly larger than the outer diameter of the cylinder core 20. The cylinder core and the tailpiece are so arranged in the cavity 12 that they overlap axially, wherein the radial hole 24 of the cylinder core and the hole 46 of the tailpiece are axially aligned to each other, see FIG. 1c. An interconnection pin 26 is provided in the hole 24 of the cylinder lock for radial movement between a disconnecting position, see FIG. 1c, and an interconnecting position, see FIG. 1d. In the latter position, the interconnection pin 26 engages the hole 46 in the tailpiece, effectively transferring a rotational movement of the cylinder core 20 to a corresponding rotational movement of the tailpiece 40.

The movement of the interconnection pin 26 is provided by means of an actuating means in the form of an electric motor 28 provided inside the cylinder core 20. The electric motor is controlled by means of the electronic authorization means 32 in the knob 30.

The operation of the lock device 1 will now be explained in detail. In the position of the interconnection pin 26 shown in FIG. 1c, when the knob 40 is turned, the cylinder core turns or rotates with the knob. However, with the cylinder core 20 and the tailpiece 40 being rotationally disconnected, the tailpiece will not turn or rotate with the cylinder core. A lock mechanism connected to the integrated coupling 44 will thus not operate and a door in which the lock mechanism is provided is therefore locked.

In FIG. 1d, an electronic remote control 34 is shown. By means of this remote control, which can be of any kind, such as a so-called Dallas Chip or other kind of transmitter, the electronic authorizing means 32 is controlled to the effect that the actuating means 28 moves the interconnection pin 26 from the disconnected position shown in FIG. 1c to the connected position shown in FIG. 1d. After actuating the pin, a person turning the knob 30 will also turn the tailpiece 40, effectively operating the lock mechanism to unlock the door in which it is provided.

The use of a radially movable pin or other means to interconnect or disconnect a cylinder core and a tailpiece proves to be a simple, flexible and reliable way of providing a locking function to a lock cylinder.

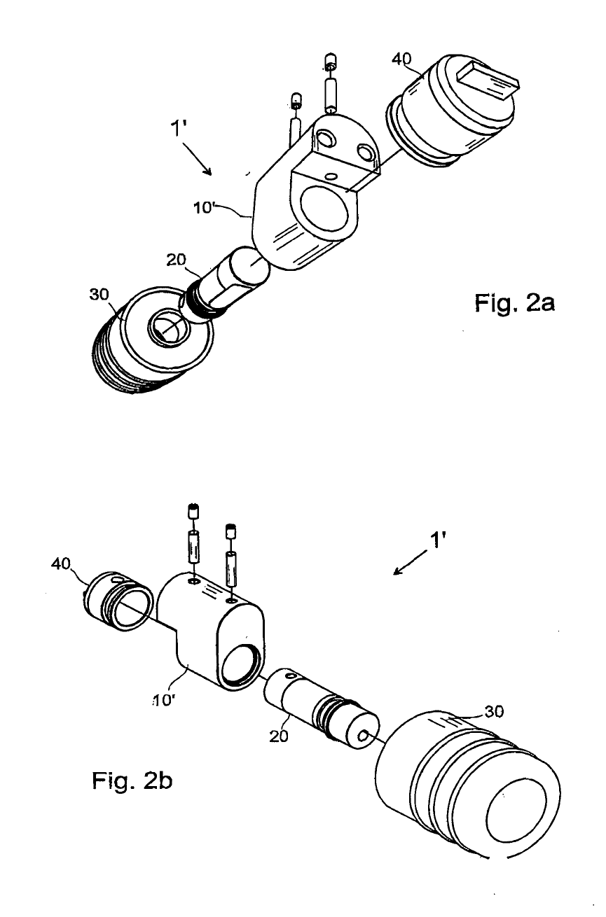

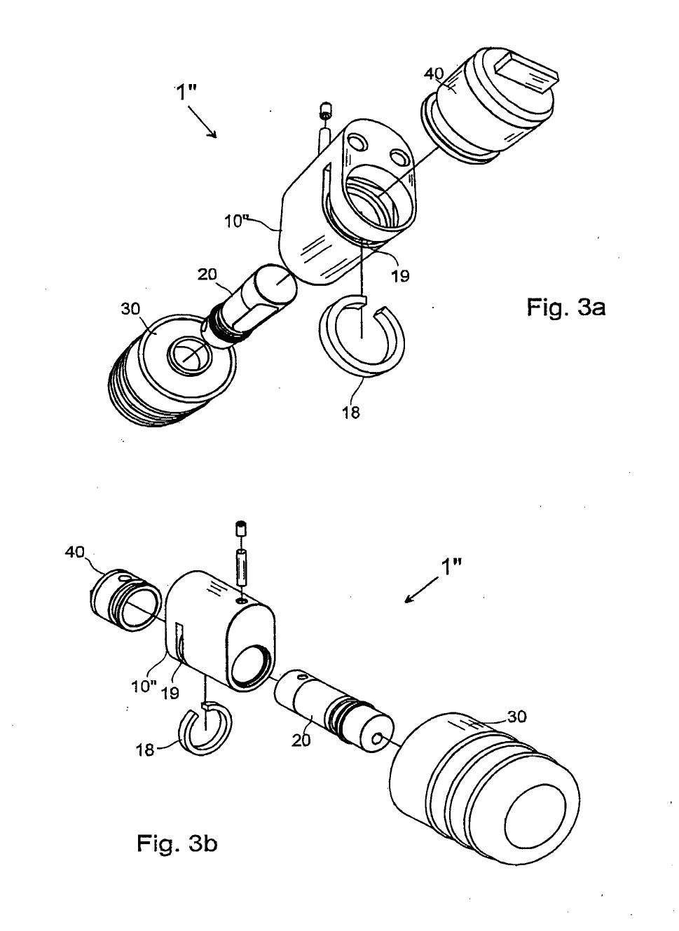

In FIGS. 2a-b and 3a-b, respectively, are shown alternative embodiments 1′ and 1″ of a lock device according to the invention. In the embodiment of FIGS. 2a and 2b the cylinder house 10′ has a modified shape while in the embodiment of FIGS. 3a and 3b the tailpiece 40 is secured axially in the cylinder house 10″ by means of a clip 18 running in a groove 19 in the cylinder house.

Different embodiments of the cylinder house are shown. It will be appreciated that the inventive lock device can comprise a tailpiece of many different shapes. The same cylinder house and cylinder core can be maintained as long as the tailpiece has means, such as a circumferential groove, for axially fixating it to the cylinder house.

Preferred embodiments of a lock device according to the invention have been described. A person skilled in the art realises that these could be varied within the scope of the appended claims. Thus the term “actuating means” used in the description is intended to cover rotational or linear motors, solenoids etc.

Knob-operated lock cylinders have been shown and described. It will be realized that the inventive idea of using a radial pin for interconnecting a cylinder core and a tailpiece is applicable also for other kinds of lock cylinders, such as key operated ones.

1. A lock device comprising:
a cylinder house;
a substantially cylindrical cylinder core which is rotatably accommodated in said cylinder house and fixed against axial displacement relative to the cylinder house;
a tailpiece which is rotatably accommodated in said cylinder house and fixed against axial displacement relative to the cylinder house;
characterized by
an interconnection means which is radially moveable between a disconnecting position, wherein it engages only the cylinder core, and an interconnecting position, wherein it engages both the cylinder core and the tailpiece.

2. The lock device according to claim 1, wherein the tailpiece is cup shaped and comprises a cylindrical portion and an essentially planar bottom.

3. The lock device according to claim 2, wherein the inner diameter of the cylindrical portion of the cup shaped tailpiece is slightly larger than the outer diameter of the cylinder core, and wherein the cylinder core and the tailpiece are so arranged in the cavity that they overlap axially.

4. The lock device according to claim 1, wherein a radial hole in the cylinder core and a hole in the tailpiece are axially aligned to each other.

5. The lock device according to claim 1, wherein the interconnection means comprises a radially movable pin provided in a radial hole in the cylinder core.

6. The lock device according to claim 1, wherein at least one of the cylinder core and the tailpiece is fixated axially by means of a lock pin in the cylinder house engaging a circumferential groove in the cylinder core and the tailpiece, respectively.

7. The lock device according to claim 1, wherein at least one of the cylinder core and the tailpiece is fixated axially by means of a clip provided in a groove in the cylinder house engaging a circumferential groove in the cylinder core and the tailpiece, respectively.

8. The lock device according to claim 1, comprising an actuating means and an electronic authorization means, wherein the actuating means is arranged to move the interconnection means under control of the electronic authorization means.

9. The lock device according to claim 8, wherein the actuating means comprises an electric motor.
